(19) United States
(12) Patent Application Publication
(10) Pub. No.: US 2026/0043930 A1
(43) Pub. Date: Feb. 12, 2026

(54) DEPTH MIGRATION IN SEISMIC IMAGING

(71) Applicant: Saudi Arabian Oil Company, Dhahran (SA)

(72) Inventors: Yujin Liu, Beijing (CN); Thierry-Laurent Dominique Tonellot, Montferrier-sur-lez (FR); Young Seo Kim, Dhahran (SA); Hussain J. Salim, Dhahran (SA)

(21) Appl. No.: 18/798,490

(22) Filed: Aug. 8, 2024

(51) Int. Cl. G01V 1/30; G01V 1/32

(52) U.S. Cl. CPC G01V 1/305; G01V 1/325; G01V 2210/51

(57) ABSTRACT

Example methods and systems for seismic depth migration are disclosed. One example method includes obtaining a surface grid of a region for seismic imaging of subsurface structures of the region. The surface grid includes multiple grid cells with each having multiple vertices, and each of the multiple vertices is associated with a traveltime between the vertex and a first multiple subsurface points to be imaged. An interpolated traveltime associated with a first grid cell of the multiple grid cells and a ray tracing-based traveltime associated with the first grid cell are determined. A difference between the interpolated traveltime and the ray tracing-based traveltime is compared to a threshold. In response to determine that the difference is larger than the threshold, the first grid cell is subdivided into a first multiple smaller grid cells. The surface grid with the first multiple smaller grid cells is provided for seismic depth migration.

### TECHNICAL FIELD

The present disclosure relates to computer-implemented methods and systems for depth migration in seismic imaging.

### BACKGROUND

In depth migration during seismic imaging, reflections in seismic data are moved to their respective locations in space, including locations relative to shotpoints, where the shotpoints are seismic sources at the surface of the Earth that are activated for seismic imaging. Kirchhoff depth migration is a technique that may lead to extensive computations of traveltimes from multiple sources and receivers to subsurface points to be imaged, resulting in significant computational and storage overhead.

### SUMMARY

The present disclosure involves methods and systems for depth migration in seismic imaging. One example method includes obtaining a surface grid of a region for seismic imaging of subsurface structures of the region, where the surface grid includes multiple grid cells, each of the multiple grid cells has multiple vertices, and each vertex of the multiple vertices is associated with a traveltime between the vertex and a first multiple subsurface points to be imaged. An interpolated traveltime associated with a point in a first grid cell of the multiple grid cells is determined by interpolating the traveltimes associated with the multiple vertices of the first grid cell. A ray tracing-based traveltime associated with the point in the first grid cell is determined through ray tracing between the point and a second multiple subsurface points influenced by the point. A difference between the interpolated traveltime and the ray tracing-based traveltime associated with the point in the first grid cell is compared to a predetermined threshold. In response to determine that the difference is larger than the predetermined threshold, the first grid cell is subdivided into a first multiple smaller grid cells. The surface grid with the first multiple smaller grid cells is provided for depth migration in the seismic imaging of subsurface structures of the region.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example process of refining a surface grid for traveltime determination during depth migration in seismic imaging, according to some implementations.

FIG. 2A illustrates an example grid cell in a surface grid, according to some implementations.

FIG. 2B illustrates an example of four refined grid cells from a subdivision process of a larger grid cell, according to some implementations.

FIG. 3A illustrates an example surface grid before grid refinement, according to some implementations.

FIG. 3B illustrates an example surface grid after grid refinement, according to some implementations.

FIG. 4 illustrates an example process for detecting leaks in power transformers, according to some implementations.

FIG. 5 is a block diagram of an example computer system that can be used to provide computational functionalities associated with described algorithms, methods, functions, processes, flows, and procedures, according to some implementations.

FIG. 6 illustrates hydrocarbon production operations that include both one or more field operations and one or more computational operations, which exchange information and control exploration for the production of hydrocarbons, according to some implementations.

Like reference numbers and designations in the various drawings indicate like elements.

### DETAILED DESCRIPTION

In depth migration for seismic imaging, for example, Kirchhoff depth migration, traveltime tables can be created to link each source/receiver pair to subsurface points that are influenced by the source/receiver pair and that are to be imaged. Kirchhoff depth migration is a method of seismic migration that uses the integral form (Kirchhoff equation) of the wave equation. In some cases, the traveltime tables can be computed and stored for a surface grid (e.g., a uniform surface grid), with the traveltime for a specific source or receiver interpolated from surface grid points nearby. However, the interpolation process can be computationally and/or storage intensive, for example, when a fine surface grid is used to ensure interpolation accuracy in areas with significant subsurface heterogeneity and/or complex topography.

This disclosure describes systems and methods of adaptively and locally adjusting cell sizes of a surface grid to determine the traveltimes of points in the surface grid during depth migration for seismic imaging. In some cases, the cell sizes of grid cells in the surface grid can be adjusted locally in areas where traveltime interpolation errors surpass a predetermined threshold.

In some cases, the disclosed methods can locally refine the density of grid cells in a surface grid such that the grid cell size is variable across the refined surface grid. The disclosed methods can also confine traveltime interpolation errors of points within the grid to within a specific threshold, thereby guaranteeing the interpolation accuracy. The disclosed methods can accommodate complex topography and subsurface heterogeneity during the generation of surface grid for depth migration in seismic imaging.

The disclosed systems and methods provide many advantages over existing systems. As one example, the disclosed methods can ensure traveltime interpolation accuracy across the surface grid, without relying on excessive grid density. As another example, the disclosed methods can reduce computational and storage demands associated with determining traveltimes of points within the surface grid, thereby enhancing the efficiency of depth migration in seismic imaging.

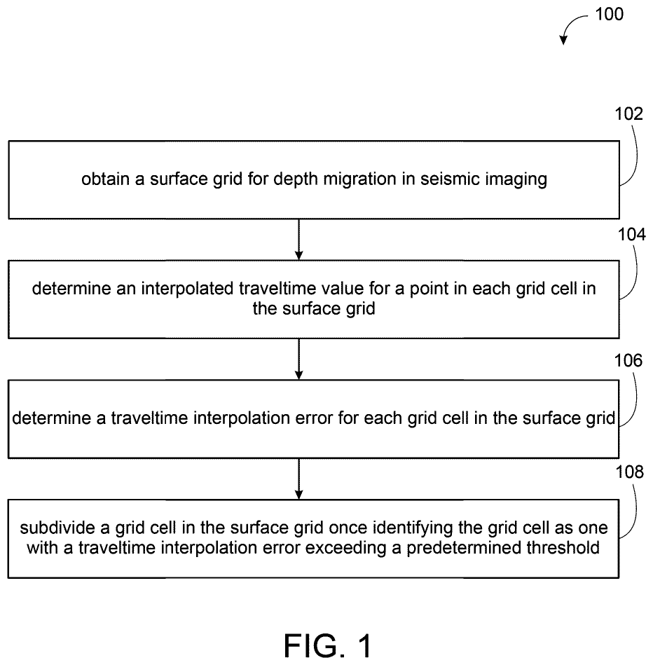

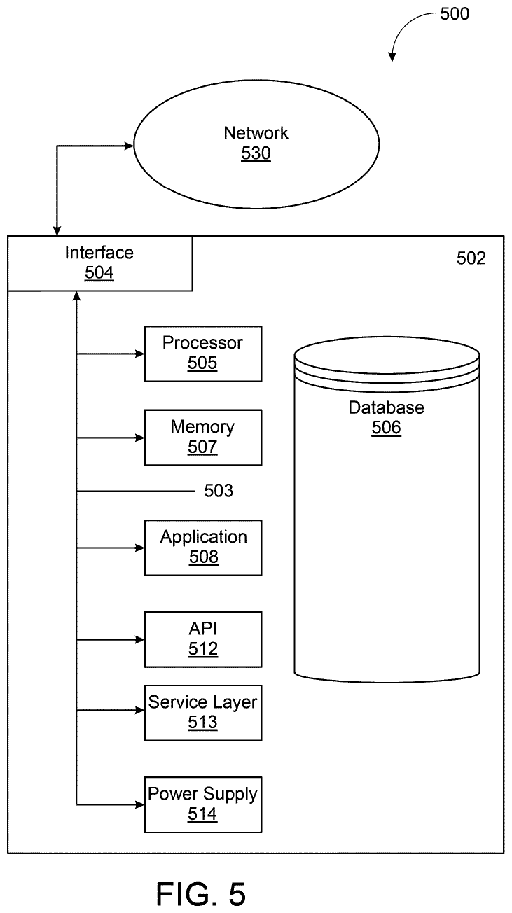

FIG. 1 illustrates an example process 100 of refining a surface grid for traveltime determination during depth migration in seismic imaging. For convenience, process 100 will be described as being performed by a computer system having one or more computers located in one or more locations and programmed appropriately in accordance with this specification. An example of the computer system is the computer system 500 illustrated in FIG. 5.

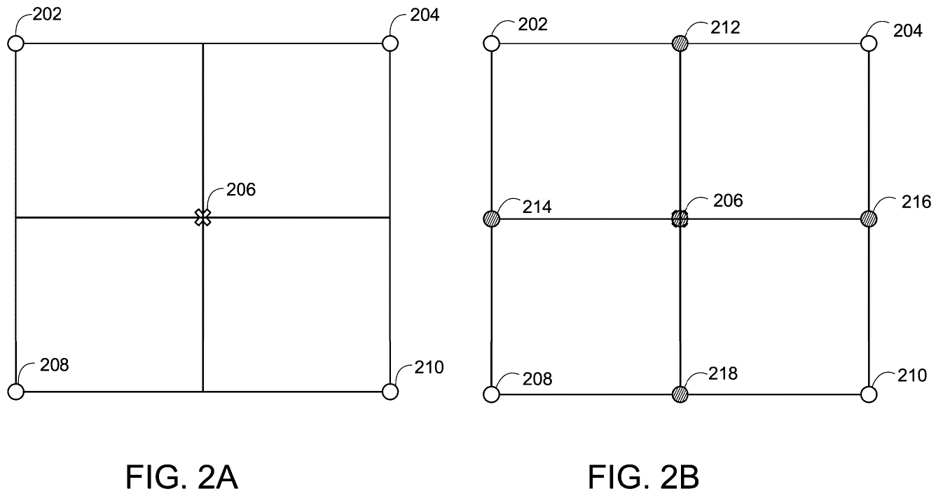

At 102, a computer system obtains a surface grid for depth migration in seismic imaging, for example, Kirchhoff depth migration. The surface grid includes multiple grid cells. Each of the multiple grid cells is a polygon with multiple vertices, for example, a quadrilateral with four vertices. FIG. 2A illustrates an example grid cell in a surface grid. The grid cell is a quadrilateral with four vertices 202, 204, 208, and 210. The grid cell has a central point 206. Each grid cell in the surface grid can have multiple vertices, where each vertex of the multiple vertices can have predetermined traveltime values associated with it. The predetermined traveltime values are traveltimes between the vertex and multiple subsurface points to be imaged respectively.

At 104, the computer system determines an interpolated traveltime value for a point in each grid cell in the surface grid, for example, a central point of each grid cell in the surface grid. In some implementations, the computer system can determine the interpolated traveltime value for the central point of a grid cell via interpolation of the traveltime values at the four vertices of the grid cell.

At 106, the computer system determines a traveltime interpolation error for each grid cell in the surface grid. In some implementations, the computer system can determine the traveltime interpolation error of a grid cell by comparing the traveltime interpolation value for the central point of the grid cell from 104 to a traveltime value determined (e.g., using statistical metrics such as mean, median, or specific percentiles) from ray tracing-based traveltime values between the central point of the grid cell and subsurface points influenced by the central point and to be imaged. In some cases, given a shot at the surface location, for example, at the central point 206 in FIG. 2A, and the subsurface velocity model, the traveltime from the shot to every subsurface point influenced by the shot can be calculated by ray tracing. This ray-traced traveltime can be used as a benchmark to assess the accuracy of the traveltime at the shot that is interpolated from the traveltime values at the four vertices of the grid cell that are adjacent to the shot.

In some implementations, the traveltime interpolation error of the grid cell can be evaluated at the grid cell's central point through statistical analysis of the discrepancies between ray-traced traveltime and interpolated traveltime at the central point of the grid cell. The traveltime interpolation error can be represented using the mean, median, and/or specific percentiles of the discrepancies, either directly from traveltime tables used in depth migration or transformed into slowness or celerity domains.

For example, the slowness transformation can be represented by Equation 1 below.

$$s = \frac{t}{l} , \qquad ( 1 )$$

where s is the slowness of a traveltime between a surface grid point and a subsurface point to be imaged, t is the traveltime, and l is the straight-line distance from the surface grid point to the subsurface point. The subsurface point can be a point on a subsurface grid.

The celerity transformation can be represented by Equation 2 below.

$$c = \frac{l}{t} , \qquad ( 2 )$$

where c is the celerity of the traveltime t.

At 108, the computer system subdivides a grid cell in the surface grid once identifying the grid cell as one with a traveltime interpolation error exceeding a predetermined threshold. In some implementations, the subdivision process introduces intermediary grid points at the midsections of the grid cell's periphery, thereby reducing each of the grid cell dimensions by half. For example, the subdivision of the grid cell in FIG. 2A can introduce five new grid points 212, 214, 216, 218 and the central point 206 in FIG. 2B, thereby increasing the local grid density of the surface grid at the grid cell. FIG. 2B illustrates an example of four refined grid cells from a subdivision process of a larger grid cell.

In some implementations, the subdivision process can be iterated if the traveltime interpolation error at the central point of a newly formed grid cell from the subdivision process, for example, a grid cell formed by points 202, 212, 214, and 206 in FIG. 2B, still exceeds the predetermined threshold, thereby further refining the surface grid until the traveltime interpolation error at the central point of each grid cell in the surface grid is reduced below the predetermined threshold, or until the surface grid dimensionality conforms to a predetermined magnitude.

In some implementations, the traveltime interpolation error at the central point of a grid cell can be evaluated against an error bound parameter, for example, the predetermined threshold. The error bound parameter can be determined using Equation 3 below.

$$Δ t = \frac{1}{2 {f}_{max}} , \qquad ( 3 )$$

where fₘₐₓ is the seismic data's maximum frequency. In some cases, fₘₐₓ can be below 100 Hz in seismic exploration, and therefore, according to Equation 3, the interpolation error is less than 5 milliseconds. If the traveltime interpolation error is evaluated in the slowness domain, and the maximal distance is 10 km, then the slowness error can be less than 5×10\hat{ }(−4) s/km.

In some implementations, seismic data in exploration geophysics can be used for mapping the subsurface structure of the Earth. Seismic data can be collected using seismic sensors such as geophones, seismometers, hydrophones, and/or ocean bottom seismometers. The seismic sensors can record ground movements that contain information about the Earth's interior, such as variations in seismic velocity and density. In some cases, seismic data are composed of various frequency components, which can be used to interpret subsurface geological features. The maximum frequency of seismic data can affect the resolution of seismic images. In seismic exploration the maximum frequency of seismic data can be below 100 Hz, because seismic signals with higher frequencies tend to attenuate more rapidly when traveling through the Earth, and therefore are less used in deep exploration.

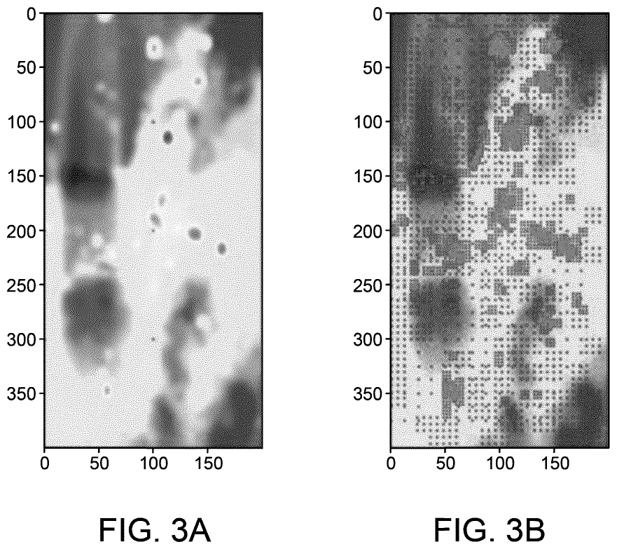

FIG. 3A illustrates an example surface grid before grid refinement. FIG. 3B illustrates an example surface grid after grid refinement. When compared to FIG. 3A, FIG. 3B shows increased density in certain areas within the surface grid. The increased density in FIG. 3B is the result of adaptive grid adjustments in local regions of the surface grid where interpolation errors exceeded a predetermined threshold, for example, 5 milliseconds, thereby safeguarding the accuracy of traveltime interpolation and the quality of the resultant seismic image. When compared to a uniform grid that achieves the same level of interpolation accuracy as that of FIG. 3B, the surface grid shown in FIG. 3B can reduce the number of grid points significantly, for example, by a factor of 20. Consequently, a twentyfold reduction in both computational and storage costs associated with the calculation of traveltimes can be achieved.

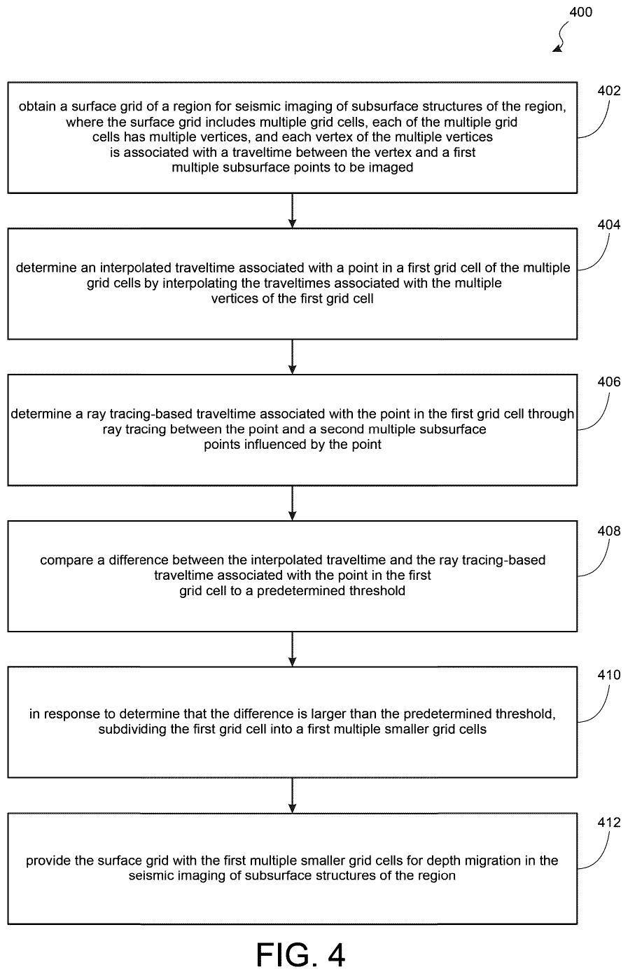

FIG. 4 illustrates an example process 400 of refining a surface grid during depth migration in seismic imaging. For convenience, process 400 will be described as being performed by a computer system having one or more computers located in one or more locations and programmed appropriately in accordance with this specification. An example of the computer system is the computer system 500 illustrated in FIG. 5.

At 402, a computer system obtains a surface grid of a region for seismic imaging of subsurface structures of the region, where the surface grid includes multiple grid cells, each of the multiple grid cells has multiple vertices, and each vertex of the multiple vertices is associated with a traveltime between the vertex and a first multiple subsurface points to be imaged.

At 404, the computer system determines an interpolated traveltime associated with a point in a first grid cell of the multiple grid cells by interpolating the traveltimes associated with the multiple vertices of the first grid cell.

At 406, the computer system determines a ray tracing-based traveltime associated with the point in the first grid cell through ray tracing between the point and a second multiple subsurface points influenced by the point.

At 408, the computer system compares a difference between the interpolated traveltime and the ray tracing-based traveltime associated with the point in the first grid cell to a predetermined threshold.

At 410, in response to determine that the difference is larger than the predetermined threshold, the computer system subdivide the first grid cell into a first multiple smaller grid cells.

At 412, the computer system provides the surface grid with the first multiple smaller grid cells for depth migration in the seismic imaging of subsurface structures of the region.

FIG. 5 is a block diagram of an example computer system 500 that can be used to provide computational functionalities associated with described algorithms, methods, functions, processes, flows, and procedures, according to some implementations of the present disclosure. In some implementations, the computer system performing process 100 or 400 can be the computer system 500, include the computer system 500, or the computer system performing process 100 or 400 can communicate with the computer system 500.

The illustrated computer 502 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 502 can include a Smart Embedded Management Agent (SEMA), such as a built-in ADLINK SEMA 2.2, and a video sync technology, such as Quick Sync Video technology supported by ADLINK MSDK+. In some examples, the computer 502 can include the MXE-5400 Series processor-based fanless embedded computer by ADLINK, though the computer 502 can take other forms or include other components.

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs 512.

The service layer 513 can provide software services to the computer 502 and other components (whether illustrated or not) that are communicably coupled to the computer 502. The functionality of the computer 502 can be accessible for all service consumers using this service layer 513. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 can include an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and manipulate data to perform the operations of the computer 502, including operations using algorithms, methods, functions, processes, flows, and procedures as described in the present disclosure.

The computer 502 can also include a database 506 that can hold data for the computer 502 and other components connected to the network 530 (whether illustrated or not). For example, database 506 can be an in-memory, conventional, or a database storing data consistent with the present disclosure. In some implementations, the database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

An application 508 can be an algorithmic software engine providing functionality according to particular needs, desires, or particular implementations of the computer 502 and the described functionality. For example, an application 508 can serve as one or more components, modules, or applications 508. Multiple applications 508 can be implemented on the computer 502. Each application 508 can be internal or external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system including computer 502, with each computer 502 communicating over network 530. Further, the terms “client”, “user”, and other appropriate terminology can be used interchangeably without departing from the scope of the present disclosure. Moreover, the present disclosure contemplates that many users can use one computer 502 and one user can use multiple computers 502.

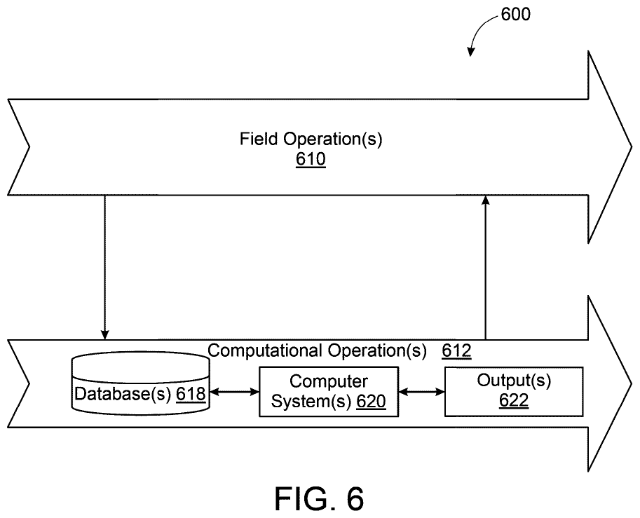

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure can be performed before, during, or in combination with the hydrocarbon production operations 600, specifically, for example, either as field operations 610 or computational operations 612, or both.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser. Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### Embodiments

Embodiment 1: A computer-implemented method that includes obtaining a surface grid of a region for seismic imaging of subsurface structures of the region, where the surface grid includes multiple grid cells, each of the multiple grid cells has multiple vertices, and each vertex of the multiple vertices is associated with a traveltime between the vertex and a first multiple subsurface points to be imaged. An interpolated traveltime associated with a point in a first grid cell of the multiple grid cells is determined by interpolating the traveltimes associated with the multiple vertices of the first grid cell. A ray tracing-based traveltime associated with the point in the first grid cell is determined through ray tracing between the point and a second multiple subsurface points influenced by the point. A difference between the interpolated traveltime and the ray tracing-based traveltime associated with the point in the first grid cell is compared to a predetermined threshold. In response to determine that the difference is larger than the predetermined threshold, the first grid cell is subdivided into a first multiple smaller grid cells. The surface grid with the first multiple smaller grid cells is provided for depth migration in the seismic imaging of subsurface structures of the region.

Embodiment 2: The computer-implemented method of embodiment 1, where after subdividing the first grid cell into the first multiple of smaller grid cells, the method further includes determining an interpolated traveltime associated with a point in a first smaller grid cell of the first multiple smaller grid cells by interpolating traveltimes associated with multiple vertices of the first smaller grid cell. A ray tracing-based traveltime associated with the point in the first smaller grid cell is determined through ray tracing between the point and a third multiple subsurface points influenced by the point. A difference between the interpolated traveltime and the ray tracing-based traveltime associated with the point in the first smaller grid cell is compared to the predetermined threshold. In response to determine that the difference is smaller than or equal to the predetermined threshold, subdividing the first smaller grid cell is refrained.

Embodiment 3: The computer-implemented method of embodiment 1 or 2, where after subdividing the first grid cell into the first multiple smaller grid cells, the method further includes determining an interpolated traveltime associated with a point in a second smaller grid cell of the first multiple smaller grid cells by interpolating traveltimes associated with multiple vertices of the second smaller grid cell. A ray tracing-based traveltime associated with the point in the second smaller grid cell is determined through ray tracing between the point and a fourth multiple subsurface points influenced by the point. A difference between the interpolated traveltime and the ray tracing-based traveltime associated with the point in the second smaller grid cell is compared to the predetermined threshold. In response to determine that the difference is larger than the predetermined threshold, subdividing the second smaller grid cell into a second multiple smaller grid cells.

Embodiment 4: The computer-implemented method of embodiment 3, where providing the surface grid with the first multiple smaller grid cells for the depth migration includes providing the surface grid with the second multiple smaller grid cells for the depth migration.

Embodiment 5: The computer-implemented method of any one of embodiments 1 to 4, where the predetermined threshold is inversely proportional to a maximum frequency of seismic data used in the seismic imaging.

Embodiment 6: The computer-implemented method of any one of embodiments 1 to 5, where the method further includes determining an interpolated traveltime associated with a point in a second grid cell of the plurality of grid cells by interpolating traveltimes associated with the multiple vertices of the second grid cell. A ray tracing-based traveltime associated with the point in the second grid cell is determined through ray tracing between the point and a fifth multiple subsurface points influenced by the point. A difference between the interpolated traveltime and the ray tracing-based traveltime associated with the point in the second grid cell is compared to the predetermined threshold. In response to determine that the difference is smaller than or equal to the predetermined threshold, subdividing the second grid cell is refrained.

Embodiment 7: The computer-implemented method of any one of embodiments 1 to 6, where the depth migration is Kirchhoff depth migration.

Embodiment 8: The computer-implemented method of any one of embodiments 1 to 7, where the point in the first grid cell is a central point of the first grid cell.

Embodiment 9: A non-transitory computer-readable medium storing one or more instructions executable by a computer system to perform operations that include obtaining a surface grid of a region for seismic imaging of subsurface structures of the region, where the surface grid includes multiple grid cells, each of the multiple grid cells has multiple vertices, and each vertex of the multiple vertices is associated with a traveltime between the vertex and a first multiple subsurface points to be imaged. An interpolated traveltime associated with a point in a first grid cell of the multiple grid cells is determined by interpolating the traveltimes associated with the multiple vertices of the first grid cell. A ray tracing-based traveltime associated with the point in the first grid cell is determined through ray tracing between the point and a second multiple subsurface points influenced by the point. A difference between the interpolated traveltime and the ray tracing-based traveltime associated with the point in the first grid cell is compared to a predetermined threshold. In response to determine that the difference is larger than the predetermined threshold, the first grid cell is subdivided into a first multiple smaller grid cells. The surface grid with the first multiple smaller grid cells is provided for depth migration in the seismic imaging of subsurface structures of the region.

Embodiment 10: The non-transitory computer-readable medium of embodiment 9, where after subdividing the first grid cell into the first multiple smaller grid cells, the operations further include determining an interpolated traveltime associated with a point in a first smaller grid cell of the first multiple smaller grid cells by interpolating traveltimes associated with multiple vertices of the first smaller grid cell. A ray tracing-based traveltime associated with the point in the first smaller grid cell is determined through ray tracing between the point and a third multiple subsurface points influenced by the point. A difference between the interpolated traveltime and the ray tracing-based traveltime associated with the point in the first smaller grid cell is compared to the predetermined threshold. In response to determine that the difference is smaller than or equal to the predetermined threshold, subdividing the first smaller grid cell is refrained.

Embodiment 11: The non-transitory computer-readable medium of embodiment 9 or 10, where after subdividing the first grid cell into the first multiple smaller grid cells, the operations further include determining an interpolated traveltime associated with a point in a second smaller grid cell of the first multiple smaller grid cells by interpolating traveltimes associated with multiple vertices of the second smaller grid cell. A ray tracing-based traveltime associated with the point in the second smaller grid cell is determined through ray tracing between the point and a fourth multiple subsurface points influenced by the point. A difference between the interpolated traveltime and the ray tracing-based traveltime associated with the point in the second smaller grid cell is compared to the predetermined threshold. In response to determine that the difference is larger than the predetermined threshold, subdividing the second smaller grid cell into a second multiple smaller grid cells.

Embodiment 12: The non-transitory computer-readable medium of embodiment 11, where providing the surface grid with the first multiple smaller grid cells for the depth migration includes providing the surface grid with the second multiple smaller grid cells for the depth migration.

Embodiment 13: The non-transitory computer-readable medium of any one of embodiments 9 to 12, where the predetermined threshold is inversely proportional to a maximum frequency of seismic data used in the seismic imaging.

Embodiment 14: The non-transitory computer-readable medium of any one of embodiments 8 to 13, where the operations further include determining an interpolated traveltime associated with a point in a second grid cell of the plurality of grid cells by interpolating traveltimes associated with the multiple vertices of the second grid cell. A ray tracing-based traveltime associated with the point in the second grid cell is determined through ray tracing between the point and a fifth multiple subsurface points influenced by the point. A difference between the interpolated traveltime and the ray tracing-based traveltime associated with the point in the second grid cell is compared to the predetermined threshold. In response to determine that the difference is smaller than or equal to the predetermined threshold, subdividing the second grid cell is refrained.

Embodiment 15: The non-transitory computer-readable medium of any one of embodiments 9 to 14, where the depth migration is Kirchhoff depth migration.

Embodiment 16: A computer-implemented system, including one or more computers and one or more computer memory devices interoperably coupled with the one or more computers and having tangible, non-transitory, machine-readable media storing one or more instructions that, when executed by the one or more computers, perform one or more operations that include obtaining moisture data of a substance in a power transformer; determining, based on the moisture data, a functional relationship between relative saturation of moisture of the substance and temperature of the substance; determining, based on the functional relationship, a gradient of the relative saturation with respect to the temperature of the substance; determining, based on the gradient, a leak of moisture of an environment surrounding the power transformer into the power transformer has occurred; and in response to determining that the leak has occurred, generating a visual alert or an audio alert to indicate that the leak has occurred.

Embodiment 17: The computer-implemented system of embodiment 16, where after subdividing the first grid cell into the first multiple smaller grid cells, the one or more operations further include determining an interpolated traveltime associated with a point in a first smaller grid cell of the first multiple smaller grid cells by interpolating traveltimes associated with multiple vertices of the first smaller grid cell. A ray tracing-based traveltime associated with the point in the first smaller grid cell is determined through ray tracing between the point and a third multiple subsurface points influenced by the point. A difference between the interpolated traveltime and the ray tracing-based traveltime associated with the point in the first smaller grid cell is compared to the predetermined threshold. In response to determine that the difference is smaller than or equal to the predetermined threshold, subdividing the first smaller grid cell is refrained.

Embodiment 18: The computer-implemented system of embodiment 16 or 17, where after subdividing the first grid cell into the first multiple smaller grid cells, the one or more operations further include determining an interpolated traveltime associated with a point in a second smaller grid cell of the first multiple smaller grid cells by interpolating traveltimes associated with multiple vertices of the second smaller grid cell. A ray tracing-based traveltime associated with the point in the second smaller grid cell is determined through ray tracing between the point and a fourth multiple subsurface points influenced by the point. A difference between the interpolated traveltime and the ray tracing-based traveltime associated with the point in the second smaller grid cell is compared to the predetermined threshold. In response to determine that the difference is larger than the predetermined threshold, subdividing the second smaller grid cell into a second multiple smaller grid cells.

Embodiment 19: The computer-implemented system of embodiment 18, where providing the surface grid with the first multiple smaller grid cells for the depth migration includes providing the surface grid with the second multiple smaller grid cells for the depth migration.

Embodiment 20: The computer-implemented system of any one of embodiments 16 to 19, where the predetermined threshold is inversely proportional to a maximum frequency of seismic data used in the seismic imaging.

We claim:

1. A computer-implemented method comprising:
obtaining a surface grid of a region for seismic imaging of subsurface structures of the region, wherein the surface grid comprises a plurality of grid cells, each of the plurality of grid cells has a plurality of vertices, and each vertex of the plurality of vertices is associated with a traveltime between the vertex and a first plurality of subsurface points to be imaged;
determining an interpolated traveltime associated with a point in a first grid cell of the plurality of grid cells by interpolating the traveltimes associated with the plurality of vertices of the first grid cell;
determining a ray tracing-based traveltime associated with the point in the first grid cell through ray tracing between the point and a second plurality of subsurface points influenced by the point;
comparing a difference between the interpolated traveltime and the ray tracing-based traveltime associated with the point in the first grid cell to a predetermined threshold;
in response to determine that the difference is larger than the predetermined threshold, subdividing the first grid cell into a first plurality of smaller grid cells; and
providing the surface grid with the first plurality of smaller grid cells for depth migration in the seismic imaging of subsurface structures of the region.

2. The computer-implemented method of claim 1, wherein after subdividing the first grid cell into the first plurality of smaller grid cells, the method further comprises:
determining an interpolated traveltime associated with a point in a first smaller grid cell of the first plurality of smaller grid cells by interpolating traveltimes associated with a plurality of vertices of the first smaller grid cell;
determining a ray tracing-based traveltime associated with the point in the first smaller grid cell through ray tracing between the point and a third plurality of subsurface points influenced by the point;
comparing a difference between the interpolated traveltime and the ray tracing-based traveltime associated with the point in the first smaller grid cell to the predetermined threshold; and
in response to determine that the difference is smaller than or equal to the predetermined threshold, refraining from subdividing the first smaller grid cell.

3. The computer-implemented method of claim 1, wherein after subdividing the first grid cell into the first plurality of smaller grid cells, the method further comprises:
determining an interpolated traveltime associated with a point in a second smaller grid cell of the first plurality of smaller grid cells by interpolating traveltimes associated with a plurality of vertices of the second smaller grid cell;
determining a ray tracing-based traveltime associated with the point in the second smaller grid cell through ray tracing between the point and a fourth plurality of subsurface points influenced by the point;
comparing a difference between the interpolated traveltime and the ray tracing-based traveltime associated with the point in the second smaller grid cell to the predetermined threshold; and
in response to determine that the difference is larger than the predetermined threshold, subdividing the second smaller grid cell into a second plurality of smaller grid cells.

4. The computer-implemented method of claim 3, wherein providing the surface grid with the first plurality of smaller grid cells for the depth migration comprises:
providing the surface grid with the second plurality of smaller grid cells for the depth migration.

5. The computer-implemented method of claim 1, wherein the predetermined threshold is inversely proportional to a maximum frequency of seismic data used in the seismic imaging.

6. The computer-implemented method of claim 1, further comprising:
determining an interpolated traveltime associated with a point in a second grid cell of the plurality of grid cells by interpolating traveltimes associated with the plurality of vertices of the second grid cell;
determining a ray tracing-based traveltime associated with the point in the second grid cell through ray tracing between the point and a fifth plurality of subsurface points influenced by the point;
comparing a difference between the interpolated traveltime and the ray tracing-based traveltime associated with the point in the second grid cell to the predetermined threshold; and
in response to determine that the difference is smaller than or equal to the predetermined threshold, refraining from subdividing the second grid cell.

7. The computer-implemented method of claim 1, wherein the depth migration is Kirchhoff depth migration.

8. The computer-implemented method of claim 1, wherein the point in the first grid cell is a central point of the first grid cell.

9. A non-transitory computer-readable medium storing one or more instructions executable by a computer system to perform operations comprising:
obtaining a surface grid of a region for seismic imaging of subsurface structures of the region, wherein the surface grid comprises a plurality of grid cells, each of the plurality of grid cells has a plurality of vertices, and each vertex of the plurality of vertices is associated with a traveltime between the vertex and a first plurality of subsurface points to be imaged;
determining an interpolated traveltime associated with a point in a first grid cell of the plurality of grid cells by interpolating the traveltimes associated with the plurality of vertices of the first grid cell;
determining a ray tracing-based traveltime associated with the point in the first grid cell through ray tracing between the point and a second plurality of subsurface points influenced by the point;
comparing a difference between the interpolated traveltime and the ray tracing-based traveltime associated with the point in the first grid cell to a predetermined threshold;
in response to determine that the difference is larger than the predetermined threshold, subdividing the first grid cell into a first plurality of smaller grid cells; and
providing the surface grid with the first plurality of smaller grid cells for depth migration in the seismic imaging of subsurface structures of the region.

10. The non-transitory computer-readable medium of claim 9, wherein after subdividing the first grid cell into the first plurality of smaller grid cells, the operations further comprise:
determining an interpolated traveltime associated with a point in a first smaller grid cell of the first plurality of smaller grid cells by interpolating traveltimes associated with a plurality of vertices of the first smaller grid cell;
determining a ray tracing-based traveltime associated with the point in the first smaller grid cell through ray tracing between the point and a third plurality of subsurface points influenced by the point;
comparing a difference between the interpolated traveltime and the ray tracing-based traveltime associated with the point in the first smaller grid cell to the predetermined threshold; and
in response to determine that the difference is smaller than or equal to the predetermined threshold, refraining from subdividing the first smaller grid cell.

11. The non-transitory computer-readable medium of claim 9, wherein after subdividing the first grid cell into the first plurality of smaller grid cells, the operations further comprise:
determining an interpolated traveltime associated with a point in a second smaller grid cell of the first plurality of smaller grid cells by interpolating traveltimes associated with a plurality of vertices of the second smaller grid cell;
determining a ray tracing-based traveltime associated with the point in the second smaller grid cell through ray tracing between the point and a fourth plurality of subsurface points influenced by the point;
comparing a difference between the interpolated traveltime and the ray tracing-based traveltime associated with the point in the second smaller grid cell to the predetermined threshold; and
in response to determine that the difference is larger than the predetermined threshold, subdividing the second smaller grid cell into a second plurality of smaller grid cells.

12. The non-transitory computer-readable medium of claim 11, wherein providing the surface grid with the first plurality of smaller grid cells for the depth migration comprises:
providing the surface grid with the second plurality of smaller grid cells for the depth migration.

13. The non-transitory computer-readable medium of claim 9, wherein the predetermined threshold is inversely proportional to a maximum frequency of seismic data used in the seismic imaging.

14. The non-transitory computer-readable medium of claim 9, wherein the operations further comprise:
determining an interpolated traveltime associated with a point in a second grid cell of the plurality of grid cells by interpolating traveltimes associated with the plurality of vertices of the second grid cell;
determining a ray tracing-based traveltime associated with the point in the second grid cell through ray tracing between the point and a fifth plurality of subsurface points influenced by the point;
comparing a difference between the interpolated traveltime and the ray tracing-based traveltime associated with the point in the second grid cell to the predetermined threshold; and
in response to determine that the difference is smaller than or equal to the predetermined threshold, refraining from subdividing the second grid cell.

15. The non-transitory computer-readable medium of claim 9, wherein the depth migration is Kirchhoff depth migration.

16. A computer-implemented system comprising:
one or more computers; and
one or more computer memory devices interoperably coupled with the one or more computers and having tangible, non-transitory, machine-readable media storing one or more instructions that, when executed by the one or more computers, cause the computer-implemented system to perform one or more operations comprising:
obtaining a surface grid of a region for seismic imaging of subsurface structures of the region, wherein the surface grid comprises a plurality of grid cells, each of the plurality of grid cells has a plurality of vertices, and each vertex of the plurality of vertices is associated with a traveltime between the vertex and a first plurality of subsurface points to be imaged;
determining an interpolated traveltime associated with a point in a first grid cell of the plurality of grid cells by interpolating the traveltimes associated with the plurality of vertices of the first grid cell;
determining a ray tracing-based traveltime associated with the point in the first grid cell through ray tracing between the point and a second plurality of subsurface points influenced by the point;
comparing a difference between the interpolated traveltime and the ray tracing-based traveltime associated with the point in the first grid cell to a predetermined threshold;
in response to determine that the difference is larger than the predetermined threshold, subdividing the first grid cell into a first plurality of smaller grid cells; and
providing the surface grid with the first plurality of smaller grid cells for depth migration in the seismic imaging of subsurface structures of the region.

17. The computer-implemented system of claim 16, wherein after subdividing the first grid cell into the first plurality of smaller grid cells, the one or more operations further comprise:
determining an interpolated traveltime associated with a point in a first smaller grid cell of the first plurality of smaller grid cells by interpolating traveltimes associated with a plurality of vertices of the first smaller grid cell;
determining a ray tracing-based traveltime associated with the point in the first smaller grid cell through ray tracing between the point and a third plurality of subsurface points influenced by the point;
comparing a difference between the interpolated traveltime and the ray tracing-based traveltime associated with the point in the first smaller grid cell to the predetermined threshold; and
in response to determine that the difference is smaller than or equal to the predetermined threshold, refraining from subdividing the first smaller grid cell.

18. The computer-implemented system of claim 16, wherein after subdividing the first grid cell into the first plurality of smaller grid cells, the one or more operations further comprise:
determining an interpolated traveltime associated with a point in a second smaller grid cell of the first plurality of smaller grid cells by interpolating traveltimes associated with a plurality of vertices of the second smaller grid cell;
determining a ray tracing-based traveltime associated with the point in the second smaller grid cell through ray tracing between the point and a fourth plurality of subsurface points influenced by the point;
comparing a difference between the interpolated traveltime and the ray tracing-based traveltime associated with the point in the second smaller grid cell to the predetermined threshold; and
in response to determine that the difference is larger than the predetermined threshold, subdividing the second smaller grid cell into a second plurality of smaller grid cells.

19. The computer-implemented system of claim 18, wherein providing the surface grid with the first plurality of smaller grid cells for the depth migration comprises:
providing the surface grid with the second plurality of smaller grid cells for the depth migration.

20. The computer-implemented system of claim 16, wherein the predetermined threshold is inversely proportional to a maximum frequency of seismic data used in the seismic imaging.
